(19) United States
(12) Patent Application Publication
(10) Pub. No.: US 2016/0229059 A1
(43) Pub. Date: Aug. 11, 2016

(54) Robot Repelling System and Method for Repelling a Robotic Device

(71) Applicant: Ali Ebrahimi Afrouzi, San Jose, CA (US)

(72) Inventor: Ali Ebrahimi Afrouzi, San Jose, CA (US)

(73) Assignee: AI Incorporated, Toronto (CA)

(21) Appl. No.: 15/018,772

(22) Filed: Feb. 8, 2016

Related U.S. Application Data
(60) Provisional application No. 62/113,495, filed on Feb. 8, 2015.

(51) Int. Cl. B25J 9/16

(52) U.S. Cl. CPC B25J 9/1676; B25J 9/1694

(57) ABSTRACT

The present disclosure provides a robot-repelling system comprising a repelling device and robots equipped with signal receivers and a method of use thereof. The portable robot-repelling device defines a virtual boundary for the robots in its vicinity through wireless signal transmissions such as radio frequencies, light, sonar etc. The device may take the form of an accessory and be worn by or attached to a human or animal, causing compatible robots in the vicinity to turn away from the virtual boundary whenever it is encountered.

### CROSS-REFERENCE TO RELATED APPLICATIONS

This application claims the benefit of provisional patent application Ser. No. 62113495, filed Feb. 8, 2015 by the present inventor.

### FIELD OF THE INVENTION

The present application relates generally to robotic devices, and in particular to robotic devices with a means for receiving wireless signals from an outside source.

### BACKGROUND OF INVENTION

The following is a tabulation of some prior art that presently appears relevant:

U.S. Patent Documents

| Patent Number | Kind Code | Issue Date | Patentee |
|---|---|---|---|
| 8,996,171 | B2 | 2015 Mar. 31 | Deere and Co |
| 8,686,679 | B2 | 2014 Apr. 1 | iRobot Corp |
| 7,196,487 | B2 | 2007 Mar. 27 | iRobot Corp |
| 6,690,134 | B1 | 2004 Feb. 10 | iRobot Corp |
| 8,659,245 | B2 | 2014 Feb. 25 | iRobot Corp |
| 8,368,339 | B2 | 2013 Feb. 5 | iRobot Corp |

U.S. Patent Application Publications

| Publication Nr | Kind Code | Publ. Date | Applicant |
|---|---|---|---|
| 20080084174 | A1 | 2008 Apr. 10 | iRobot Corp |
| 20150006015 | A1 | 2015 Jan. 1 | iRobot Corp |
| 20040244138 | A1 | 2004 Dec. 9 | Sharper Image Corp |
| 20150234385 | A1 | 2014 Aug. 20 | iRobot Corp |

The invention relates to a method and system for repelling robots. As robots become more and more widely used, the frequency of encounters between humans and robots increases. In some cases, it is beneficial for robots to keep a certain distance from humans or other moving beings, like pets. A collision between certain robots and humans or animals might be dangerous in some cases. For example, a robotic lawn mower, which has blades, could injure a person or animal that it collides with. Some people may not feel safe around robots despite all the safety features provisioned by the manufacturer. Some people may not feel their pets and children are safe around their robots.

There have been many systems proposed in the prior art for confining a robot. These systems are not often portable and are used essentially to confine the robot in a specific physical space for the purpose of performing work. This is normally achieved through providing navigation and orientation for the robot such that the robot either travels along a predetermined path and/or monitors its current location against a map stored in memory. These systems are not efficient when dealing with a mobile boundary for example an animal or a human being that would move and change location.

### SUMMARY OF INVENTION

The present disclosure provides a robot repelling system comprising a repelling device and a robot. The repelling device comprises: a signal emitter that is activated by an input device placed in a housing wherein the emitter emits a signal; the robot comprises: a signal receiver, a motor to move the robot in a movement path, a control unit controlling the movement path, wherein the robot is configured to change direction upon reaching a minimum allowable distance from the repelling device. In one embodiment the minimum allowable distance is set by a predetermined range of the signal and the robot alters the movement path upon detecting the signal. In an alternative embodiment the minimum allowable distance is transmitted to the robot by an information packet carried by the signal.

Accordingly, the present invention has several objects and advantages.

It is a goal of the present invention to provide a method for defining a virtual boundary for robots that keeps robots from approaching humans or other animals beyond a certain distance.

It is a goal of the present invention to provide a boundary that is portable and may be carried, attached to, or worn by the user.

It is a goal of the present invention to provide a method for decreasing or eliminating the possibility of collisions by robots into humans or animals.

It is a goal of the present invention to provide a method to ensure the safety of individuals or animals in the vicinity of a robotic device.

While the embodiments explained in the detailed description section are for autonomous devices, a person skilled in the art will recognize that the present invention can be used in any number of robotic applications where a minimum distance between a robot and a mobile or stationary object is needed such as: different types of indoor and outdoor autonomous robotic devices as well as systems equipped with navigation systems.

### BRIEF DESCRIPTION OF DRAWINGS

Non-limiting and non-exhaustive features of the present invention are described with reference to the following figures, wherein like reference numerals refer to like parts throughout the various figures.

FIG. 1 illustrates an embodiment of the robot-repelling system according to the invention wherein the minimum allowable distance between the repelling device and the robot is set by adjusting the signal range.

FIG. 2 illustrates an alternative embodiment of the robot-repelling system according to the invention in which the minimum allowable distance between the signal emitter and the robot is set by an information packet carried by the signal.

FIG. 3 is a flow-chart illustration of the robot repelling method of an embodiment of the invention wherein the signal range sets the minimum allowable distance between the repelling device and the robot;

FIG. 4 is a flow-chart illustration of the robot repelling method algorithm of an embodiment of the invention wherein the minimum allowable distance is set by an information packet carried by the signal.

FIG. 5 illustrates a robot comprising a signal receiver, a control unit, and a motor embodying features of the present invention.

### DETAILED DESCRIPTION OF THE INVENTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention

Various embodiments are described herein below, including methods. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention. The disclosure described herein is directed generally to one or more methods and/or systems that generate a minimum allowable distance for restricting robotic devices from approaching a repelling device.

As understood herein, the term “robot” or “robotic device” may be defined generally to include one or more devices having communication, mobility, and/or processing elements. For example, a robot or robotic device may comprise a casing or shell, a chassis including a set of wheels, a motor to drive wheels, a receiver that acquires signals transmitted from, for example, a transmitting beacon, a processor, and/or controller that processes and/or controls motor and other robotic operations, network or wireless communications, power management, etc.

As understood herein, the term “emitter” may be defined generally to include one or more devices having ability to send out a signal and includes any kind of transmitters and transceivers. Preferably the emitters provided are portable and self-powered. The emitters could be omnidirectional and emit signals either continuously or at predefined intervals.

The term “signal” used herein, may refer to radio frequencies, sonar, light, infra red, ultraviolet, laser or any other type of wireless signal.

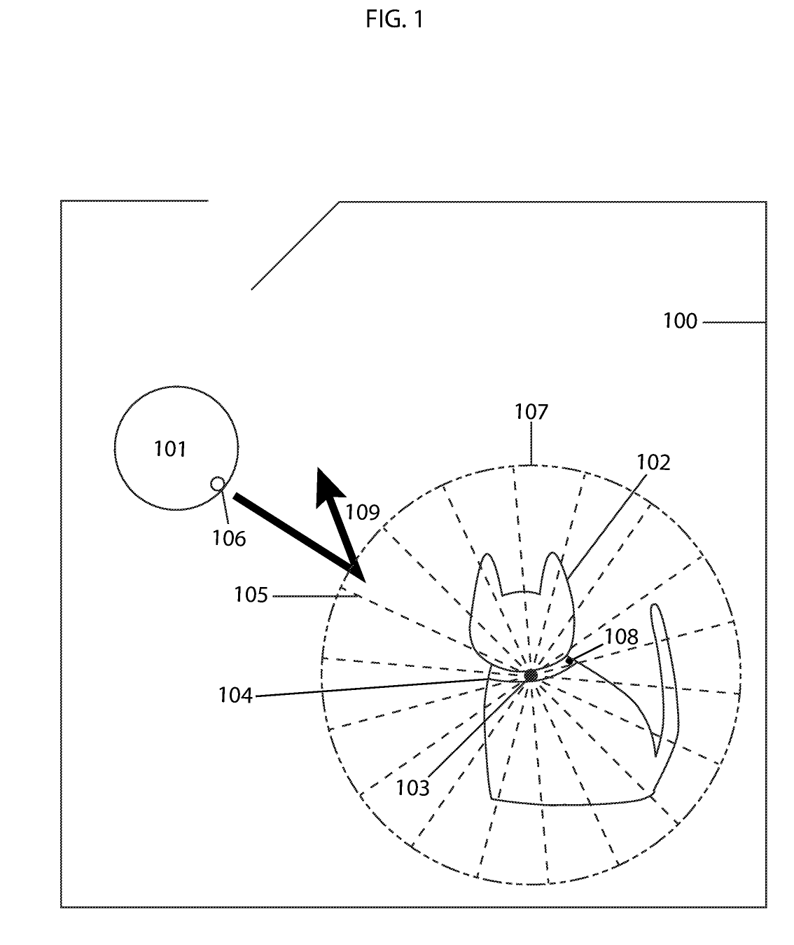

Referring to FIG. 1, the robot repelling system used to keep a robot from approaching too close to a pet is illustrated. Room 100 is shown containing a robot 101 and a pet 102. A signal emitter 103 is positioned in a housing 104 which may be attached to the pet. The signal emitter emits signals 105 detectable by the signal receiver 106 positioned on the robot when the robot is within the a range 107 of the signals. An input device 108 may be used to turn on the signal emitter. When the signal emitter is turned on, if the robot enters the area of the signal range 107, it will detect the signals 105 by the signal receiver 106. Upon detection of the signals, the robot is configured to alter its movement path 109 so that the signals are no longer detectable by the signal receiver 106.

In some embodiments, the housing 104 may contain a plurality of signal emitters, each signal emitter having a different signal range. A user can adjust the allowable distance between the robot and the repelling device by choosing the signal emitter with the desired range through the input device.

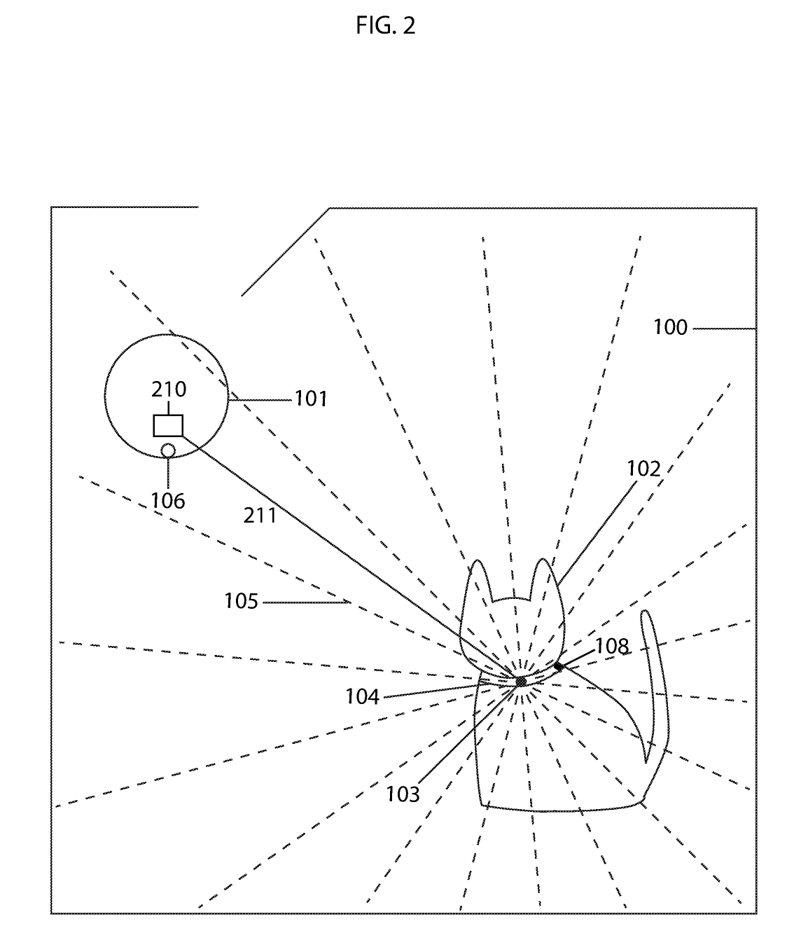

Referring to FIG. 2, an alternative embodiment of the robot repelling system is illustrated. In this embodiment, a minimum allowable distance between the signal emitter 103 and the robot 101 is predetermined and included in a packet of information carried by the signals 211. Room 100 is shown containing the robot 101, including the signal receiver 106, and the pet 102. The signal emitter 103 is positioned in the housing 104 attached to the pet. In this embodiment, the robot further comprises a means 210 for determining a distance 210 to the signal emitter. The signal emitter 103 sends signals 211 which carry a packet of information (not shown) identifying the minimum allowable distance between the signal emitter 103 and the distance determining tool 210. A user may turn on the signal emitter 103 via the input device 105 which causes the signal emitter 103 to begin sending signals 211 containing the minimum allowable distance between the distance determining tool 210 and the signal emitter. The receiver 106 receives the signal containing the minimum allowable distance between the distance determining tool and the signal emitter. Using the distance determining tool 210, the system determines the distance 211 to the signal emitter 103. If the distance 211 is smaller than or equal to the minimum allowable distance indicated by the signal, the robot is caused to alter its movement path until the distance 211 is greater than the minimum allowable distance between the distance determining tool and the signal emitter.

It shall be appreciated by one skilled in the art that in other embodiments any number of of known input devices may be used, such as keypads, toggle devices, voice activated switches, timers, control systems, optical sensors, wireless switches connected to applications, software applications or any other wireless control device, etc. Also, the means for measuring distance between the distance determining tool 210 and the signal emitter 103 can be any available non contact measuring system, such as electronic distance meters, ultrasonic ranging modules (sonar, echo sounding), radar distance measurement devices, laser rangefinders, lidar, etc.

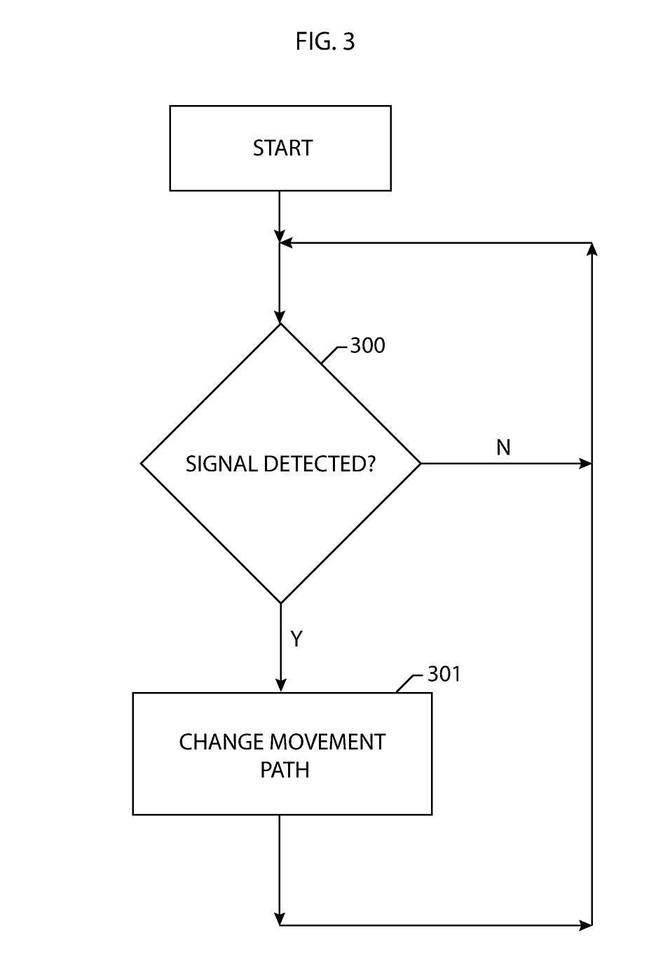

Referring to FIG. 3, a flow-chart of the control logic of the robot repelling method is illustrated. In some embodiments, the minimum allowable distance between the signal emitter and the compatible robot is determined by the range of the signal. In a first step 300, the receiver searches for the signal. If the signal is not detected, the robot continues its movement path and continues to search for the signal. If the signal is detected, the method proceeds to a step 301 in which the robot alters its movement path such that it returns to an area where the signal is no longer received. Various movement patterns for returning to an area where the signal is no longer received are possible; the robot may use any available method for altering the movement path. The method then proceeds back to step 300.

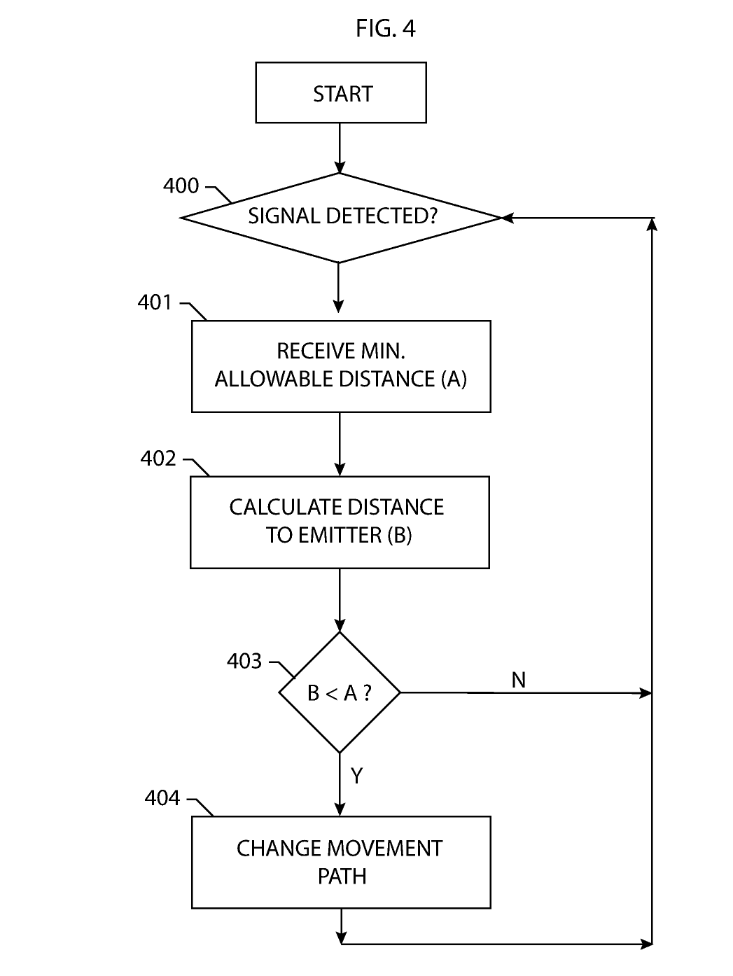

Referring to FIG. 4, a flow-chart of another embodiment of the invention is illustrated. As described previously, in some embodiments, the minimum allowable distance between the robot (or a component thereof) and the signal emitter is determined by an information packet carried by the signal. In a first step 400, the receiver searches for the signal. If the signal is not detected, the robot continues its movement path and continues to search for the signal. If the signal is detected, the method proceeds to a step 401, in which the system receives the minimum allowable distance A between the robot (or a component thereof) and the signal emitter. In a next step 402, the robot determines a distance B to the repelling device. In a next step 403, the method compares values B and A. If B is less than or equal to A, the method proceeds to a step 404 in which the robot changes its movement path such that it moves away from the signal emitter until such a point that B is greater than A. If B is greater than A, the method returns to step 402.

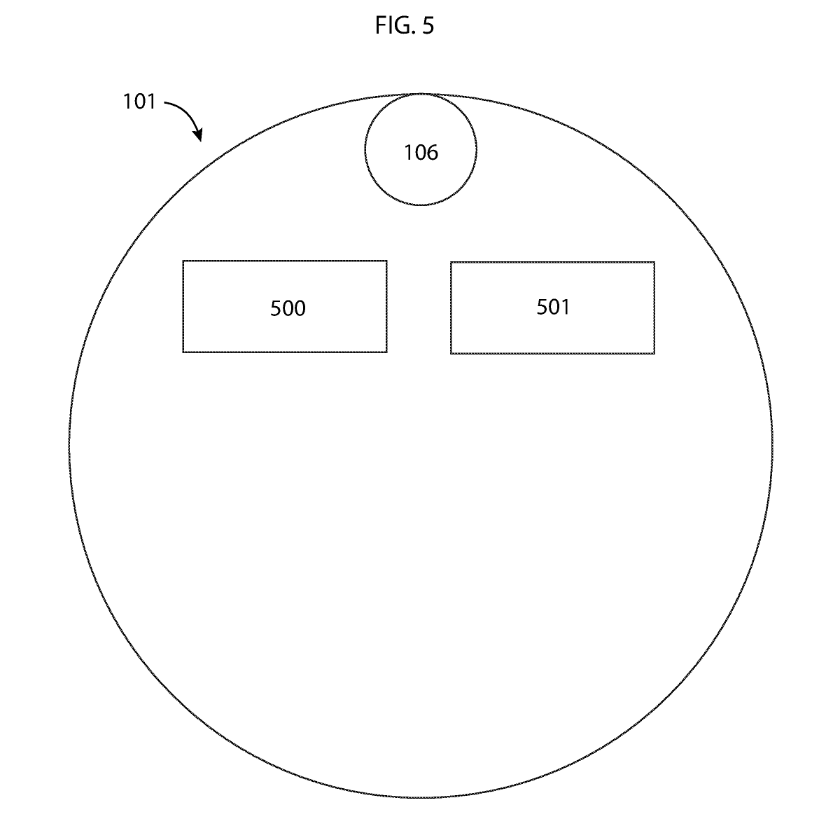

Referring to FIG. 5, an overhead view of a robot 101 is illustrated. The robot comprises, at minimum, a signal receiver 106, a motor 500, and controller unit 501.

A person skilled in the art will recognize that the present invention can be used in any number of robotic applications where a minimum distance between a robot and a mobile or stationary object is needed, such as different types of autonomous robotic devices as well as systems with a navigation system.

What is claimed is:

1. A portable robot repelling system, comprising:
a portable repelling device comprising:
a housing;
a signal emitter, positioned in said housing, emitting an omnidirectional signal; and
an input device for activating the signal emitter; and
a robot, comprising:
a signal receiver to receive said signal;
a motor to move the robot in a movement path; and
a controller unit to control the movement path of the robot;
wherein the robot is configured to alter its movement path upon reaching a minimum allowable distance from the signal emitter such that it moves in a direction away from the signal emitter until it is at least the minimum allowable distance from the signal emitter.

2. The system of claim 1 wherein the minimum allowable distance between the robot and the signal emitter is defined as the range of the omnidirectional signals.

3. The system of claim 1 further comprising one or more additional signal emitters positioned within the housing emitting omnidirectional signals of different ranges, whereby the minimum allowable distance may be adjusted by a user by selecting the desired signal emitter range via the input device.

4. The system of claim 1, further comprising:
a means for determining a distance between the robot or a component thereof and the emitter;
an information packet contained within the omnidirectional signals indicating the minimum allowable distance between the robot or a component thereof and the signal emitter;
wherein the minimum allowable distance is reached when the distance between the robot or a component thereof and the emitter is equal or smaller than the minimum allowable distance as defined by the information packet.

5. The system of claim 1 wherein the signal emitter emits signals continuously or at predefined intervals.

6. A method for repelling a robot, the method comprising:
emitting an omnidirectional signal from at least one signal emitter;
searching for the signal using a signal receiver positioned on a robot;
adjusting a movement path of the robot upon reaching a minimum allowable distance from the signal emitter.

7. The method in claim 6 wherein the minimum allowable distance is reached upon detecting the signal.

8. The method in claim 6, further comprising:
determining a distance between the signal emitter and the robot or a component thereof;
defining the minimum allowable distance from the signal emitter to the robot or a component thereof through a packet of information transmitted within the signal;
wherein the minimum allowable distance is reached when distance between the signal emitter and the robot or a component thereof is less than or equal to the minimum allowable distance.

12. The method of claim 6 wherein the minimum allowable distance may be adjusted by a user through an input device that activates signal emitters based on their signal range.
